(19) United States
(12) Patent Application Publication
(10) Pub. No.: US 2021/0133695 A1
(43) Pub. Date: May 6, 2021

(54) VEHICLE LIFE CYCLE MANAGEMENT

(71) Applicant: Wells Fargo Bank, N.A., San Francisco, CA (US)

(72) Inventors: Tambra Nichols, Charlotte, NC (US); Landon Massey, Huntersville, NC (US); Jonathan Austin Hartsell, Mooresville, NC (US); Kathy Balding, Matthews, NC (US); Marshall Dyson, Mooresville, NC (US); Suhas D. Sankolli, Charlotte, NC (US); Dennis Frederick Gutknecht, Charlotte, NC (US); Sharon B. Drawdy, Clyo, GA (US)

(21) Appl. No.: 15/604,945

(22) Filed: May 25, 2017

(51) Int. Cl. G06Q 10/00; G06Q 40/02

(52) U.S. Cl. CPC G06Q 10/20; B60K 35/00; G06Q 40/025

(57) ABSTRACT

A vehicle life cycle management system includes receiving real time vehicle information from a plurality of sensors associated with a vehicle. Financial information associated with an owner of the vehicle and external vehicle information are also received. A user interface including maintenance and financial information regarding the vehicle is generated based on the received information, and the user interface is displayed in the vehicle.

### BACKGROUND

Many people require vehicles for various transportation needs such as moving people and cargo to and from desired destinations. Owning a personal vehicle is often a major expense for individuals. Further, technology associated with vehicles is becoming more and more complicated. For example, an autonomous vehicle is a vehicle that can detect its surroundings and navigate with little or no human input. Techniques such as radar, a global positioning system (GPS) and computer vision can be used to navigate the autonomous vehicle. Financial decisions associated with vehicles are also becoming more and more complicated for vehicle owners.

### SUMMARY

In accordance with certain aspects of the present disclosure, a vehicle life cycle management system includes receiving real time vehicle information from a plurality of sensors associated with a vehicle. Financial information associated with an owner of the vehicle and external vehicle information are also received. A user interface including maintenance and financial information regarding the vehicle is generated based on the received information, and the user interface is displayed in the vehicle and/or a user device, such as a mobile phone. The vehicle is an autonomous vehicle in some examples.

The vehicle may be configured to communicate with a processor configured to perform analysis of the received information from the vehicle sensors, as well as the external vehicle and financial information. The external vehicle information may include, for example, sales information regarding comparable vehicles, maintenance data regarding the vehicle and similar vehicles, etc. The user interface may further display various recommendations based on the information analysis.

### DESCRIPTION OF THE DRAWINGS

FIG. 1 is a block diagram illustrating an example of a vehicle life cycle management system in accordance with aspects of the present disclosure.

FIG. 2 is a block diagram conceptually illustrating aspects of an example of an autonomous vehicle.

FIG. 3 is a block diagram illustrating examples of information received by the system shown in FIG. 1.

FIG. 4 conceptually illustrates an example of a user interface of the system shown in FIG. 1.

FIG. 5 conceptually illustrates an example of a finance view of the user interface shown in FIG. 4.

FIG. 6 is a process flow diagram illustrating an example of a method implemented by the system shown in FIG. 1.

FIG. 7 a block diagram illustrating portions of an example computer system.

### DETAILED DESCRIPTION

In the following Detailed Description, reference is made to the accompanying drawings, which form a part hereof, and in which is shown by way of illustration specific embodiments in which the invention may be practiced. The following detailed description, therefore, is not to be taken in a limiting sense.

Individually owned and operated vehicles provide convenient means for transporting passengers and cargo. However, such vehicles are becoming more and more complicated (and expensive) to operate, repair and maintain as vehicle technology advances. Accordingly, managing financial aspects of vehicle ownership and operation is also becoming more and more complicated.

As used herein, an autonomous or self-driving vehicle refers to a vehicle that can detect its surroundings and navigate with little or no human input. Techniques such as radar, a global positioning system (GPS) and computer vision can be used to navigate the autonomous vehicle. Many vehicles, and especially autonomous vehicles, have many instruments and sensors to provide information and status regarding various systems and components of the vehicle, assist with navigation, and even drive the vehicle in the case of an autonomous vehicle. Thus, much information is available to the owner and/or operator of the vehicle. However, such on-board instruments and sensors do not provide adequate information for managing the vehicle's life cycle and making financial decisions regarding the vehicle.

Systems and processes disclosed herein provide, for example, real time information for a vehicle owner or user regarding various systems of the vehicle, as well as financial information and recommendations associated with the vehicle to simplify management of the vehicle lifecycle. A user interface is provided that may be displayed in the vehicle itself, and/or on an external device such as a user's device such as a smart phone. Several data sources are monitored, such as the various sensors providing real-time information regarding various systems of the vehicle, as well as external data including historical information regarding the current vehicle, taxes, insurance, market data regarding maintenance and repair costs, replacement costs for buying or leasing a replacement vehicle, etc. Rules are applied to the monitored data to manage maintenance, repairs, selling and purchasing a vehicle. Thus, a financial interface automatically tracks repair and maintenance costs, replacement vehicle costs, as well as the user's bank account information to help the user finance such vehicle-related costs. For example, based on the collected data, recommendations for repairing or replacing a vehicle may be displayed, along with a preapprove loan for financing such recommendations.

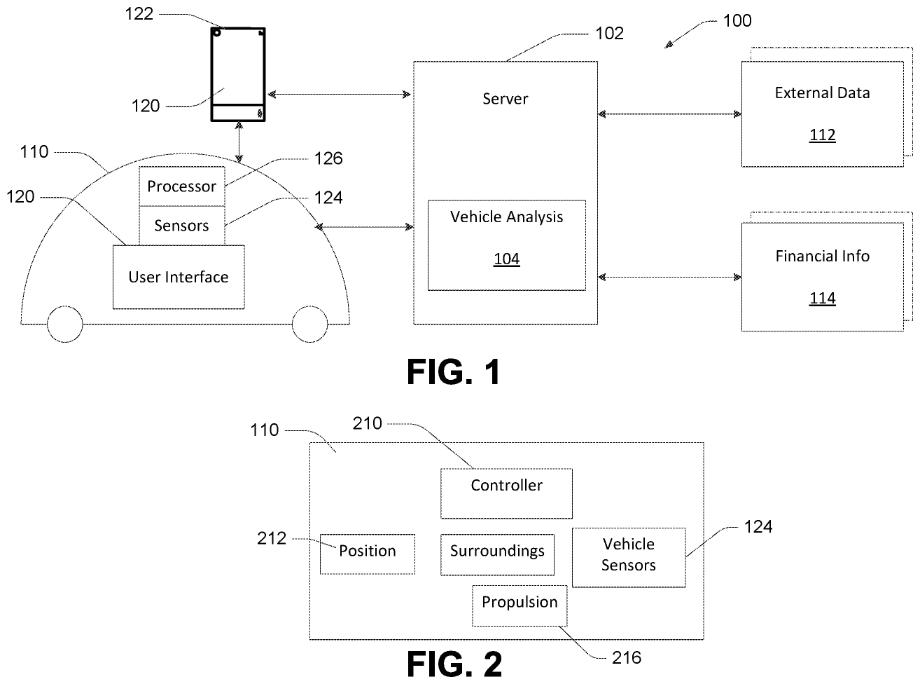

FIG. 1 illustrates an example vehicle lifecycle management system 100 that includes a vehicle 110, which is an autonomous or self-driving vehicle in some implementations. A computer system 102, such as a server computer, includes a processor and a memory accessible by the processor storing program instructions that configure the computer 102 to implement a vehicle analysis system 104. In some examples, the server 102 can be one of a network of servers (e.g., a “cloud”) of the system 100. Further, each server in the network of servers can be adapted to perform a specific function or functions on behalf of the system 100. Although specific functionalities will be attributed to the server 102 in this disclosure, it should be appreciated that the same functionalities can be divided among a network of interconnected servers. Thus, throughout this disclosure, the server 102 can alternatively be understood as a single server or a network of servers.

One or more user interfaces 120 are configured to display and receive vehicle lifecycle management information. In the illustrated example, the user interface 120 is displayed in the vehicle 110. Additional user interfaces 120 could be implemented on a user device 122, which could be any of a number of suitable devices such as a desktop computer, laptop computer, tablet device, smart phone, wearable and implantable devices, etc. that communicates with the server 102, for example, via a network such as the internet. The user device 122 may also interface with the vehicle 110 by any suitable means, such as by a wired connection, an internet connection, wife, Bluetooth, etc.

The vehicle includes several sensors 124 that provide real-time information concerning various aspects of the vehicle 110. An on-board computer including a processor 126 interfaces with the sensors 124 to provide information to the vehicle operator, among other things.

The server computer 102 interacts with one or more external data sources 112 to obtain external vehicle information, and also with financial data sources 114 to obtain relevant financial information regarding the vehicle 110 and its owner/operator. The information from the sensors 124, along with the external vehicle information 112 and the financial information 114 are processed by the vehicle analysis system 104 to display maintenance and financial information on the user interface 120.

In some embodiments, the vehicle 110 is an autonomous vehicle that is operated with little or no input from a human driver. In further embodiments, the vehicle analysis system 104 is configured to manage and provide information regarding a fleet of the vehicles 110. FIG. 2 is a block diagram illustrating aspects of an example autonomous vehicle 110, which includes a vehicle controller 210 implemented by the processor 126 that operates the vehicle. The example autonomous vehicle 110 is a self-driving vehicle, for example a self-driving car. The controller 210 provides instructions in the form of control signals (such as driving and stopping signals) to the appropriate components of the autonomous vehicle 110. The vehicle controller 210 communicates with the server 102 via a communications network, such as the Internet.

The controller 210 includes a positioning device 212 that can receive and transmit position data to the controller 210. The location of the vehicle 110 at any given time can be determined by the positioning device 212 or another appropriate positioning system. Examples of such positioning devices 212 include GPS systems and devices. The vehicle controller 210 further includes a surroundings detection system 214 configured to detect the surroundings of the vehicle 110 by appropriate detection systems such as radar, laser light, GPS, odometry, computer vision, etc. The controller 210 is configured to interpret location, surroundings, and other sensory information to identify appropriate navigation paths, as well as obstacles and relevant driving information, and output control signals to a propulsion system 216 that includes appropriate components (energy, propulsion, transmission, steering, etc.) for driving the vehicle 110. The vehicle sensors 124 monitor these and other components of the vehicle 110, providing data to the controller 210.

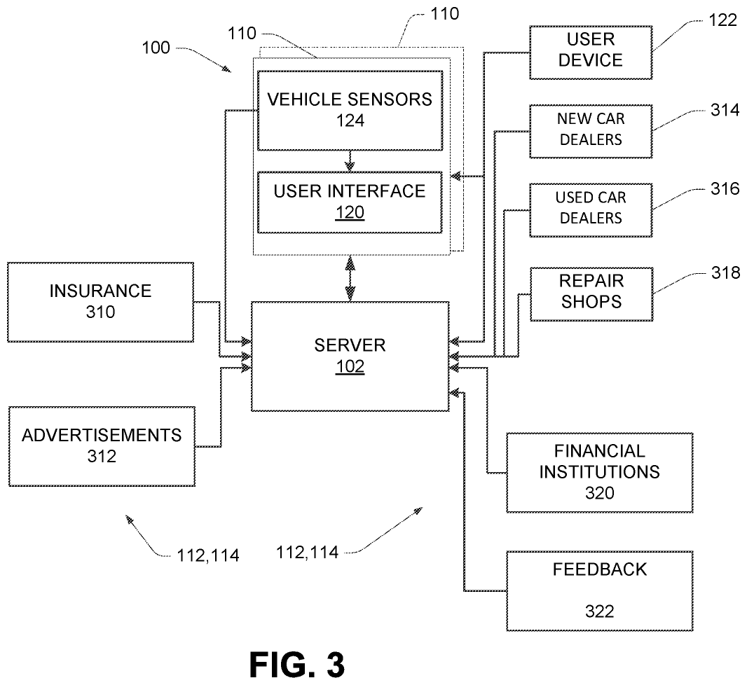

FIG. 3 is a block diagram illustrating further aspects of the system 100, including examples of the various data sources 112, 114 with which the server 102 interacts. The vehicle analysis system 104 implemented by the server 102 is configured to interact with the various external vehicle information 112 and financial data 114 to provide real time vehicle lifecycle management information and recommendations to a user via the user interface 120. Thus, the vehicle analysis system 104 is configured to analyze not only information received from the vehicle sensors 124, but also the external data 112, 114. Accordingly, the analysis system 104 implemented by the server 102 is configured to implement various analytic functions such as business process management, cognitive analytics, data integration, security functions, etc., based on predetermined rules.

As shown in FIG. 3, the server interacts with the vehicle 110 (or a plurality of vehicles 110 in the case of a fleet of vehicles), and also external data sources 112 to get real time information regarding the vehicle(s) 110, possible replacement vehicles, maintenance information, etc., as well as financial information 114 related to the user and/or the vehicle. The external data sources include insurance companies 310, from which the system 104 receives information regarding insurance rates for the vehicle(s) 110 and possible replacement vehicles. Insurance companies 310 also may provide information regarding accident rates, repair costs, driver accident rates, etc. The system 104 receives additional external vehicle information from various vehicle advertisements, such as online automobile classified sources such as auto.com, autotrader.com, cars.com, craigslist, Edmunds.com, kbb.com, etc. Such advertising information 312 provides market data, allowing the analysis system to determine replacement vehicle costs, among other things. For example, by analyzing ads for the same or similar models as the vehicle 110, trends in buying and selling that vehicle may be determined, as well as establishing sales value of the vehicle and costs to replace the vehicle.

Additional external vehicle information may be obtained from, for example, new car dealers 314, used car dealers 316, and repair shops 318. Such external vehicle information sources provide additional information regarding potential replacement vehicle costs, costs of ownership information for the vehicle 110, maintenance and reliability information, etc. Additionally, such auto dealers and repair shops often have discount specials and discount coupons, which may be identified for the user via the user interface 120. Such specials and discounts are typically time-limited. Thus, displaying the information on the user interface 120 in real time is valuable for the user. Still further, the server 102 may be configured to interact with auto dealers 314, 316 and repair shops 318 to schedule repairs and maintenance, make appointments for viewing new vehicles, etc.

Various vehicle feedback information sources 322 include, for example, social media sites, Better Business Bureau (BBB), online reviews, etc. Such information may be aggregated and displayed on the user interface 120, and also used by the cognitive analysis component of the analysis system 104 to display and recommend possible replacement vehicles, including ranking such entities based on customer feedback.

In addition to vehicle information sources 112, the server 102 interacts with various financial institutions 320, which could include various banks, auto lenders, credit unions, etc., and also the user's bank and other financial institutions. Information sources such as insurance companies 310 and the various consumer feedback sources 322 may also provide data regarding such financial institutions, which may also be ranked and displayed on the user interface 120. By analyzing data from various auto loan sources, for example, loan rates may be obtained, as well as time-limited “special” rates advertised by such lenders. These rates may be displayed in real time on the user interface 120. Interfacing with the user's bank accounts allows the analysis system 104 to provide real-time financial information, and model and display various scenarios and recommendations regarding fix vs. replace, how to finance repair and maintenance costs, and/or how to finance a replacement vehicle purchase.

In some examples, the user interface 120 is displayed on a user device 122, such as the user's smart phone. This alternative user interface 120 may be displayed in addition to, or in place of, the user interface 120 displayed in the vehicle 110 itself. In the illustrated example, the user interface 120 on the user device 122 replicates the user interface 120 displayed in the vehicle(s) 110. The user device 122 communicates and interacts with the vehicle 110 and the server 102 to receive the generated user interface 120, allowing the user remote access to various aspects of the vehicle and displayed information. For instance, through the user device 122, the user may manage and view information from the vehicle sensors 124, manage and change security settings, receive notifications, etc.

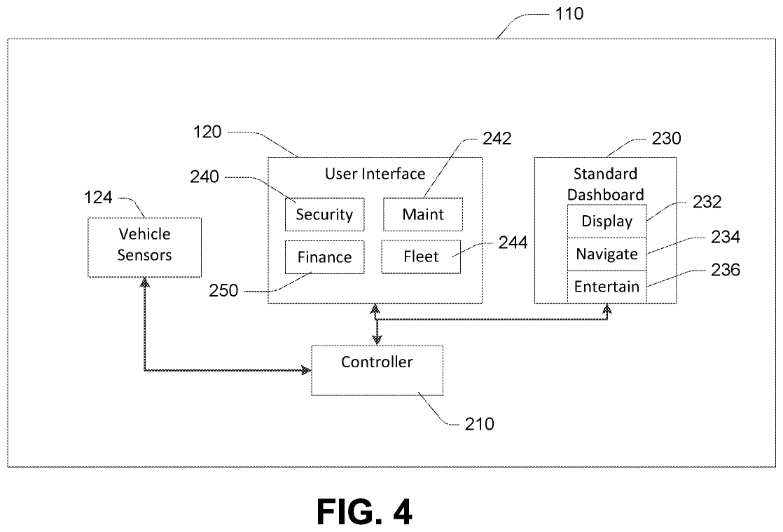

FIG. 4 is a block diagram conceptually illustrating further aspects of an example of the vehicle 110. The controller 210 interacts with the vehicle sensors, which as noted previously, provide information about various vehicle components and subsystems. Such information is typically displayed on a standard dashboard 230, which includes a display 232 which shows information such as vehicle speed, fuel level, temperature, oil pressure, tire air pressure, etc. A navigation display 234 may provide driving directions and map displays for vehicles requiring a driver, or may simply provide location information in the case of an autonomous vehicle. An entertainment display 236 provides an interface for selecting music, videos, games, etc.

In the illustrated embodiment, the user interface 120 is displayed in the vehicle 110, and also on the user device 122. In contrast to the standard vehicle dashboard 230, the example user interface provides a dynamic display of real-time vehicle and related financial information for the user. The user interface 120 includes a security module 240 that allows the user to lock the user interface 110 such that only authorized users can view it. For example, the security module 240 may be configured to password protect the user interface 120, and/or provide security using biometric identifiers such as fingerprints, voice recognition, facial recognition, retinal recognition, etc.

A maintenance module display 242 is configured to analyze information from the vehicle sensors 124 and/or receive analyzed information from the server 102 to provide further vehicle analysis information such as engine health, tire health, maintenance recommendation and reminders, etc. Based on analyzing information from the vehicle sensors 124 together with the various external data sources 112, 114, the user interface 120 is able to display recommended maintenance actions such as oil changes and lubrication, battery replacement, filter replacement, tire rotation, warranty information, as well as recommended timing, financing, discounts, coupons, vendors, etc. for the maintenance items. In embodiments where a fleet of the vehicles 110 are managed, the user interface 120 may further include a fleet display 244 providing information regarding the various vehicles 110 in the fleet, including locations, operations and maintenance status, operator information, etc.

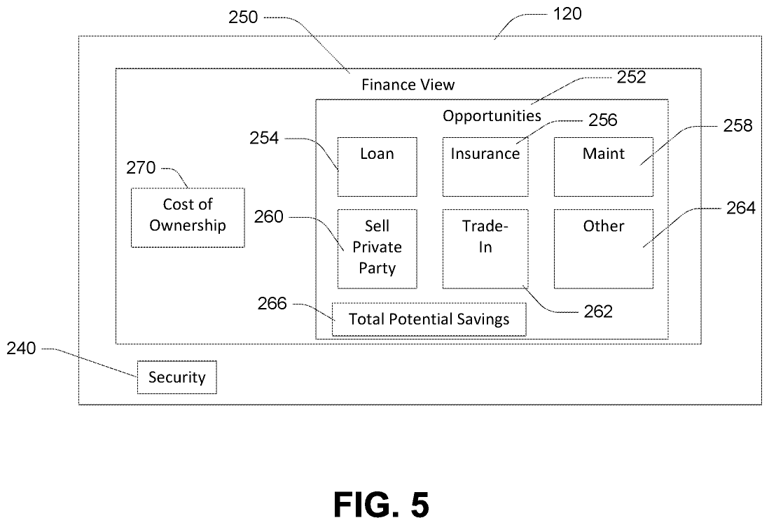

The user interface 120 further includes a finance view module 250 that provides real-time financial information for the user. FIG. 5 illustrates further aspects of an example of the financial view 250. As noted above, the security module 240 allows selective display of the user interface 120, and more specifically, the various modules. A user may desire to hide and lock the financial display and the personal information contained therein when passengers are in the vehicle or the vehicle is being operated by someone other than the owner.

The finance view 250 includes a financial “opportunities” display 252 that provides real-time advice to the vehicle owner regarding potential cost saving opportunities. For example, the opportunities display includes a loan information display 254 that displays options for reducing costs associated with financing the vehicle 110. Information regarding different lenders, interest rates, loan terms, payment amounts, etc. may be displayed. Based on analyzing the vehicle owner's bank information, the loan display 254 could make recommendations regarding using savings or liquidating investments to pay off a loan early. Other loan options, such as replacing an existing car loan with a home equity loan could further be displayed, for example. Still further, the loan display 254 could display preapproved loans for the vehicle 110, allowing the refinance the vehicle directly via the user interface 110.

An insurance opportunities display module 256 provides information regarding potential costs savings by, for example, changing insurance companies. Among other things, the insurance information 310 received may allow the analysis system 104 to monitor insurance expiration deadlines, and perform cost comparisons among various insurance policies and insurance companies to display potential insurance cost savings for the vehicle owner. For instance, by analyzing data received from the vehicle sensors 124, use of the vehicle and driving habits may be determined. Elapsed time from any accidents or traffic tickets may also be monitored. This information may then be combined with insurance information to evaluate aspects of various policies, such as amounts for comprehensive coverage, liability coverage, collision coverage, etc., and quantify potential cost savings associated therewith.

A maintenance opportunities display 258 identifies, for example, cost savings associated with time limited discounts offered by various service providers in the user's area, discount coupons and vouchers, etc. Other cost saving opportunities could result from combining services, such as replacing tires and batteries at the same time.

Display modules 260 and 262 relate to potential opportunities related to selling the vehicle 110. The display 260 provides information regarding selling the vehicle 110 to a private party, such as average selling prices for similar vehicles, date ranges for such sales, etc. Display module 262 displays information regarding dealer trade-in opportunities, as well as possible replacement vehicles. In some examples, the display 262 shows average trade in values from various dealers, date ranges of such values, location of the dealers, and potential costs resulting from trading-in the vehicle 110 for a replacement vehicle. Based on the received information, the data analysis system 104 may calculate various “keep-or-sell” scenarios and based thereon, provide related recommendations on the user interface 120. Additionally, an “other opportunities” display module 264 may be configured to provide additional financial opportunities. For example, based on information from the sensors 124, user input, etc., the analysis system 104 may determine average idle hours per day of the vehicle 110. In some instances, it may be possible to rent the vehicle 110 during such idle periods by participating in car-sharing programs or the like. The display 264 may identify and display the idle periods for the vehicle 110 (for example, non-commuting hours), potential daily or hourly rental rates, and thus potential income resulting from such use of the vehicle 110.

The opportunities display 252 also provides a display 266 showing the aggregate potential savings for various savings opportunities displayed and selected by the user via the user interface 120.

A cost of ownership display module 270 shows various financial aspects associated with owning the vehicle 110, based on information received from various data sources, including those discussed above in conjunction with FIG. 3. For example, the cost of ownership display 270 may provide real-time information regarding outstanding loan balances related to the vehicle 110, upcoming maintenance cost estimates, fuel consumption and projected consumption, insurance premiums, commercial insurance premiums in the case of commercial or shared use of the vehicle, etc.

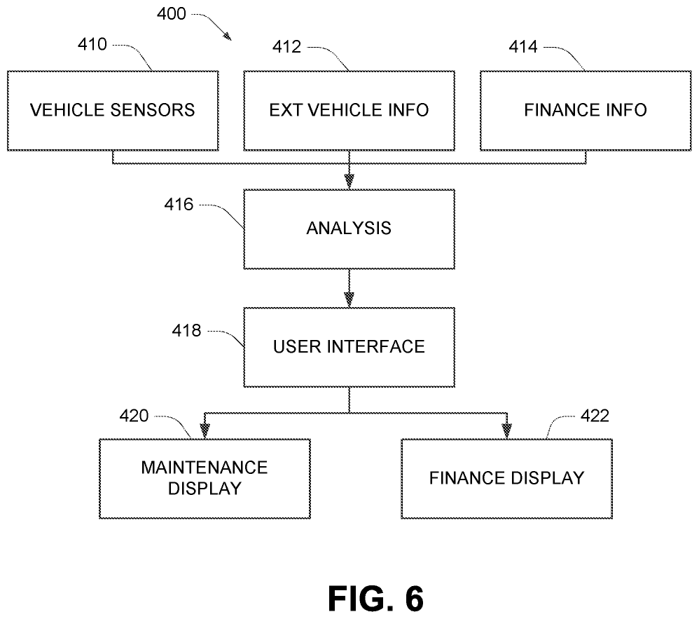

FIG. 6 illustrates an example of a process implemented by the system 100 in flow chart form. As noted above, software instructions stored in a memory assessable by the server configure the server 102 to implement the illustrated process 400, in which the server 102 receives vehicle information from the vehicle sensors 124 in block 410. The server 102 further receives external vehicle information in block 412, as well as financial information regarding the vehicle 110 and its owner/operator in block 414. The received information is processed by the vehicle analysis system 104 as shown in block 416. Based on the analysis, the user interface 120 is generated in block 418, which displays maintenance and financial information on the user interface 120 as shown in blocks 420 and 422, respectively. As noted above, the user display 120 is provided in the vehicle 110, and/or on the user device 122.

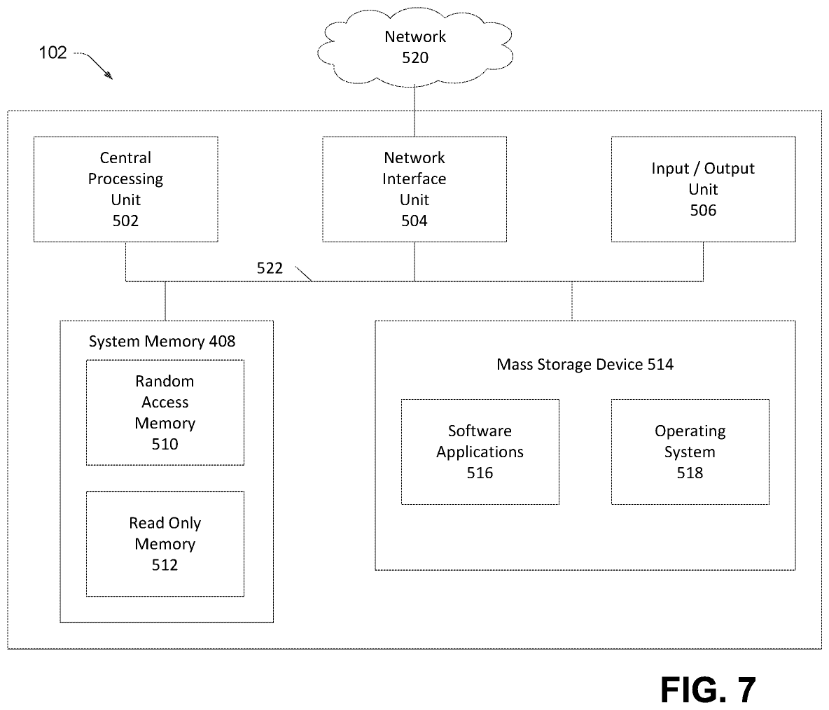

FIG. 7 schematically illustrates an example of the computer 102, which could be a server computer as discussed above. Note that the controller 210 of the vehicle 110, as well as the user device 122, may include similar structures. The computer 102 includes at least one processor (“CPU”) 502, a system memory 508, and a system bus 522 that couples the system memory 508 to the CPU 502. The system memory 508 includes a random access memory (“RAM”) 510 and a read-only memory (“ROM”) 512. A basic input/output system that contains the basic routines that help to transfer information between elements within the server computer 102, such as during startup, is stored in the ROM 512. The server computer 102 further includes a mass storage device 514. The mass storage device 514 is able to store software instructions and data. A processor, system memory and mass storage device similar to that in FIG. 7 are also included in the user device 122 and the controller 210.

The mass storage device 514 is connected to the CPU 502 through a mass storage controller (not shown) connected to the system bus 522. The mass storage device 514 and its associated computer-readable data storage media provide non-volatile, non-transitory storage for the server computer 102. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 102.

According to various embodiments of the invention, the server computer 102 may operate in a networked environment using logical connections to remote network devices through the network 520, such as a wireless network, the Internet, or another type of network. The server computer 102 may connect to the network 520 through a network interface unit 504 connected to the system bus 522. It should be appreciated that the network interface unit 504 may also be utilized to connect to other types of networks and remote computing systems. The server computer 102 also includes an input/output controller 506 for receiving and processing input from a number of other devices, including a touch user interface display screen, or another type of input device. Similarly, the input/output controller 506 may provide output to a touch user interface display screen or other type of output device.

As mentioned briefly above, the mass storage device 514 and the RAM 510 of the server computer 102 can store software instructions and data. The software instructions include an operating system 518 suitable for controlling the operation of the server computer 102. The mass storage device 514 and/or the RAM 510 also store software instructions, that when executed by the CPU 502, cause the server computer 102 to provide the functionality of the server computer 102 discussed in this document. For example, the mass storage device 514 and/or the RAM 510 can store software instructions that, when executed by the CPU 502, cause the server computer 102 to implement the vehicle analysis system 104 shown in FIG. 1 for applying the various processes described herein, among other things.

Although various embodiments are described herein, those of ordinary skill in the art will understand that many modifications may be made thereto within the scope of the present disclosure. For instance, examples related to home loans are included herein, though the disclosed systems and methods are also applicable to many other financial processes, such as personal and business loans, credit card accounts, home equity lines of credit, mortgage refinances, etc. Accordingly, it is not intended that the scope of the disclosure in any way be limited by the examples provided.

1. A system, comprising:
a processor;
a memory accessible by the processor storing program instructions that configure the processor to:
receive real time vehicle information from a plurality of sensors associated with a vehicle;
receive financial data associated with an owner of the vehicle;
receive external vehicle information;
based on the real time vehicle information from the plurality of sensors, the financial data and the external vehicle information, generate a user interface display that is displayed on a dashboard within the vehicle, wherein the user interface display includes:
a maintenance information display regarding the vehicle, the maintenance information display including real-time information about the vehicle's current condition and a recommendation of one or more maintenance actions for the maintenance of the vehicle; and
a financial information display regarding the vehicle, the finance information display including real-time financial data associated with the owner and a display of one or more cost saving financial opportunities associated with the vehicle including:
based on an analysis of the financial data of the owner, a recommendation to perform maintenance procedures on the vehicle and purchase a replacement vehicle; and
based on the analysis of the financial data of the owner, preapproved loan information to fund performance of the maintenance procedures or purchase the replacement vehicle;
based on one or more biometric identifiers, determine that the vehicle is occupied by the owner of the vehicle and show the finance data associated with the owner from the user interface display on the dashboard within the vehicle; and
upon determining that the vehicle is occupied by someone other than the owner, hide the finance data associated with the owner from the user interface display on the dashboard within the vehicle.

2. The system of claim 1, further comprising the vehicle, wherein the vehicle is configured to communicate with the processor via a network, and wherein the vehicle is configured to receive and display the user interface.

3. The system of claim 1, further comprising displaying the user interface on a mobile device.

4. The system of claim 1, wherein the vehicle is an autonomous vehicle.

5. The system of claim 1, wherein the external vehicle information includes sales information regarding comparable vehicles.

6. The system of claim 1, wherein the external vehicle information includes maintenance data regarding the vehicle.

7. The system of claim 1, wherein the external vehicle information includes maintenance data regarding comparable vehicles.

8-10. (canceled)

11. A method, comprising:
receiving real time vehicle information from a plurality of sensors associated with a vehicle;
receiving financial data associated with an owner of the vehicle;
receiving external vehicle information;
based on the real time vehicle information from the plurality of sensors, financial data and the external vehicle information, generating a user interface including:
a maintenance information display regarding the vehicle, the maintenance information display including real-time information about the vehicle's current condition and a recommendation of one or more maintenance actions for the maintenance of the vehicle; and
a financial information display regarding the vehicle, the finance information display including real-time financial data associated with the owner and a display of one or more cost saving financial opportunities associated with the vehicle;
at least one of a recommendation to perform maintenance procedures on the vehicle and purchase a replacement vehicle; and
based on the analysis of the financial data of the owner, preapproved loan information to fund performance of the maintenance procedures or purchase the replacement vehicle; and
displaying the user interface on a dashboard within the vehicle;
based on one or more biometric identifiers, determining that the vehicle is occupied by the owner of the vehicle and show the finance data associated with the owner from the user interface display on the dashboard within the vehicle; and
upon determining that the vehicle is occupied by someone other than the owner, hiding the finance data associated with the owner from the user interface display on the dashboard within the vehicle.

12. The method of claim 11, further comprising displaying the user interface on a mobile device.

13. The method of claim 11, wherein the vehicle is an autonomous vehicle.

14. The method of claim 11, wherein the external vehicle information includes sales information regarding comparable vehicles.

15. (canceled)

16. The method of claim 11, further comprising displaying a loan information for at least one of the recommendation for maintenance procedures and the replacement vehicle purchase recommendation on the user interface.

17. A computer-readable storage medium including software instructions that implement a method, comprising:
receiving real time vehicle information from a plurality of sensors associated with a vehicle;
receiving financial data associated with an owner of the vehicle;
receiving external vehicle information; and
based on the real time vehicle information from the plurality of sensors, financial data and the external vehicle information, generating a user interface that is displayed on a dashboard within the vehicle, wherein the user interface display includes:
a maintenance information display regarding the vehicle, the maintenance information display including real-time information about the vehicle's current condition and a recommendation of one or more maintenance actions for the maintenance of the vehicle; and
a financial information display regarding the vehicle, the finance information display including real-time financial data associated with the owner and a display of one or more cost saving financial opportunities associated with the vehicle;
at least one of a recommendation to perform maintenance procedures on the vehicle and purchase a replacement vehicle; and
based on the analysis of the financial data of the owner, display preapproved loan information to fund performance of the maintenance procedures or purchase the replacement vehicle;
based on one or more biometric identifiers, determining that the vehicle is occupied by the owner of the vehicle and show the finance data associated with the owner from the user interface display on the dashboard within the vehicle; and
upon determining that the vehicle is occupied by someone other than the owner, hiding the finance data associated with the owner from the user interface display on the dashboard within the vehicle.

18. The computer-readable storage medium of claim 17, wherein receiving the external vehicle information includes receiving sales information regarding comparable vehicles.

19. The computer-readable storage medium of claim 17, wherein receiving the external vehicle information includes receiving maintenance data regarding comparable vehicles.

20. (canceled)
